(19) United States
(12) Patent Application Publication
(10) Pub. No.: US 2007/0070634 A1
(43) Pub. Date: Mar. 29, 2007

(54) Light source apparatus and projector

(76) Inventor: Makoto Sato, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/521,190

(22) Filed: Sep. 14, 2006

(30) Foreign Application Priority Data
Sep. 28, 2005 (JP) 2005-283027

(51) Int. Cl. F21V 7/04; F21V 5/00

(52) U.S. Cl. 362/348; 362/327; 362/308

(57) ABSTRACT

The size and thickness of a light source apparatus 61 which includes a reflector 65 made up of a mirror having a paraboloid of revolution or the like have constituted a problem in making thin in thickness equipment such as a projector which incorporates therein the light source apparatus.

Due to this, a light source apparatus 61 is provided which includes a light source 63 in an interior of a reflector 65 which is formed into a cylindrical body and in which ring-shaped reflecting surfaces 69 are provided on the reflector 65 for gathering emitted light in an axial direction of the cylindrical body, so that a light source can be provided which is small in size and thin in thickness.

### BACKGROUND OF THE INVENTION

1. Field of the Invention

The present invention relates to a light source apparatus using a plurality of ring-shaped reflecting surfaces and a data projector having the light source apparatus installed therein to project an image based on video signals or the like.

2. Description of the Related Art

In these days, a light source apparatus such as a lamp including a reflector is applied to various applications such as a flash light and an automotive headlamp, a light source for a liquid crystal projector and an endoscope lamp attached to a distal end of an endoscope.

When applied to any of those applications, since a light source apparatus which is large in size makes difficult the design and manufacture of a product on which the large light source apparatus is installed, a smaller light source apparatus is always demanded. For example, in order to increase the degree of freedom in designing motor vehicles, a small light source apparatus is necessary, and since the endoscope has to be in such a size that allows it to be sent into the human body, a small light source is necessary.

Consequently, making light source apparatuses small in size is in constant and strong request in various fields where such small light source apparatuses find their applications, and to meet such a request, the development of small light source apparatus is in progress.

Among the applications raised above, for example, a data projector is one of products which are particularly requested to be made small in size or thin in thickness, and making small in size or thin in thickness a light source apparatus to be installed in the data projector is, in particular, in constant and strong request.

Many data projectors of this type are used to project an image displayed on a screen of a personal computer and an image in the form of video signals and, furthermore, an image by image data stored in a memory card on to a screen.

In many cases, the data projector of this type is constructed such that a light source apparatus in which a small discharge lamp having a high luminance such as a metal halide lamp and an extra-high voltage mercury lamp is incorporated is used, and light emitted from the light source apparatus is then caused to be split into the three primary colors of light by a collar filter so as to be then emitted on to a display device such as a liquid crystal display and a DMD (digital micromirror device) by a light source side optical system, so that light which has transmitted through or is reflected on the display device is projected on to a screen via a group of lens which is regarded as a projection side optical system having a zooming function.

The light source apparatus which includes the light source such as the discharge lamp is such as to reflect light emitted from the light source by a reflector so as to gather the light so reflected at a point forwards of the light source apparatus. As the shape of the reflector, a paraboloid of revolution or an ellipsoid of revolution is adopted in many cases.

These shapes are characterized in that the formation thereof is easy, but, on the other hand, with those shaped, a large reflector was necessary in order to gather much of light emitted from the light source.

In addition, as has been described before, there has existed the strong request for the data projector to be made small in size or thin in thickness. The development of small or thin data projectors has been in progress in recent years to fulfill the request, and as a result, in the current situations, the development has been in progress to such a level that a data projector can be provided in which the thickness of a projector main body is thinned to a thickness which is substantially equal to the thickness of a light source apparatus used therein like a projector shown in a Japanese Unexamined Patent Publication No. 2005-173019 (JP-A-2005-173019).

Thus, the size or thickness of the light source apparatus constitutes a problem in making the projector main body thin in thickness. Due to this, in order to make the data projector smaller in size or thinner in thickness than ever before, it is inevitable to make the light source apparatus smaller in size or thinner in thickness.

### SUMMARY OF THE INVENTION

According to a preferred aspect of the invention, there is provided a light source apparatus having a light source in an interior of a reflector which is formed into a cylindrical body, in which a ring-shaped reflecting surface is provided on the cylindrical body for gathering emitted light in an axial direction of the cylindrical body.

Furthermore, according to another preferred aspect of the invention, there is provided a projector including a light source apparatus, a light source side optical system, a display device, a projection side lens, and furthermore, a power supply circuit and a projector control circuit, wherein the light source apparatus includes a discharge lamp having a high luminance at a center of a reflector which is formed into a cylindrical shape and has a number of ring-shaped reflecting surfaces on an outer circumferential surface of the reflector for gathering light in an axial direction of the cylindrical shape, and wherein the reflecting surfaces are disposed in such a manner as to gather light emitted from the discharge lamp having a high luminance which is made to make up a light source to a forward point in an axial direction of the reflector.

### BRIEF DESCRIPTION OF THE DRAWINGS

FIG. 1 is a perspective view showing exemplarily a light source apparatus according to the invention.

FIG. 2 is a sectional view showing exemplarily reflectors and a discharge lamp of the light source apparatus according to the invention.

FIG. 3 is a sectional view showing exemplarily reflectors of another type and the discharge lamp of the light source apparatus according to the invention.

FIG. 4 is a sectional view showing exemplarily another light source apparatus according to the invention.

FIG. 5 is an exemplary diagram showing a horizontal section of a data projector which incorporates therein the light source apparatus according to the invention.

FIG. 6 is an external view showing of the example of the data projector which incorporates therein the light source apparatus according to the invention.

### DETAILED DESCRIPTION OF THE PREFERRED EMBODIMENT

According to an aspect of the invention, there is provided a light source apparatus including a light source of a discharge lamp having a high luminance at a center of a reflector which is formed into a cylindrical shape, in which a number of ring-shaped reflecting surfaces are provided on an outer circumferential surface of the reflector, so as to gather light emitted from the light source to a forward point in an axial direction of the reflector by the ring-shaped reflecting surfaces.

In addition, according to another aspect of the invention, there is provided a projector including the light source apparatus, a light source side optical system, a display device, a projection system lens and, furthermore, a power supply circuit and a projector control circuit.

Note that there may also be a case where the light source of the light source apparatus is made up of a light emitting diode or a miniature electric lamp, or another light emitting element to be applied to a light source apparatus for various types of apparatuses and equipment.

Hereinafter, the preferred embodiment of the invention will be described in detail by reference to the accompanying drawings.

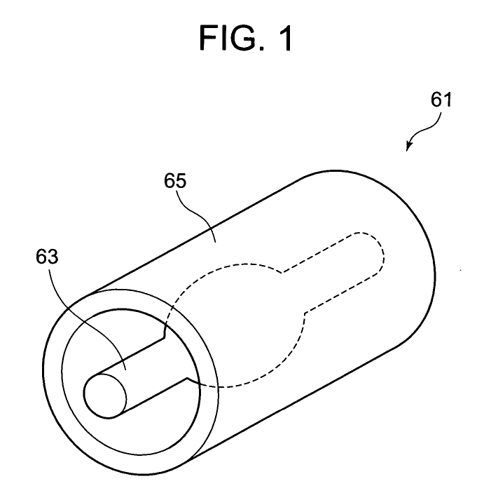

As is shown in FIG. 1, a light source apparatus according to the invention is such as to have a light source 63 made up of a discharge lamp or a light emitting diode in a center axis position of a reflector 65, and this reflector 65 is such as to be formed into a cylindrical body having a cylindrical shape in which front and rear diameters thereof are equal.

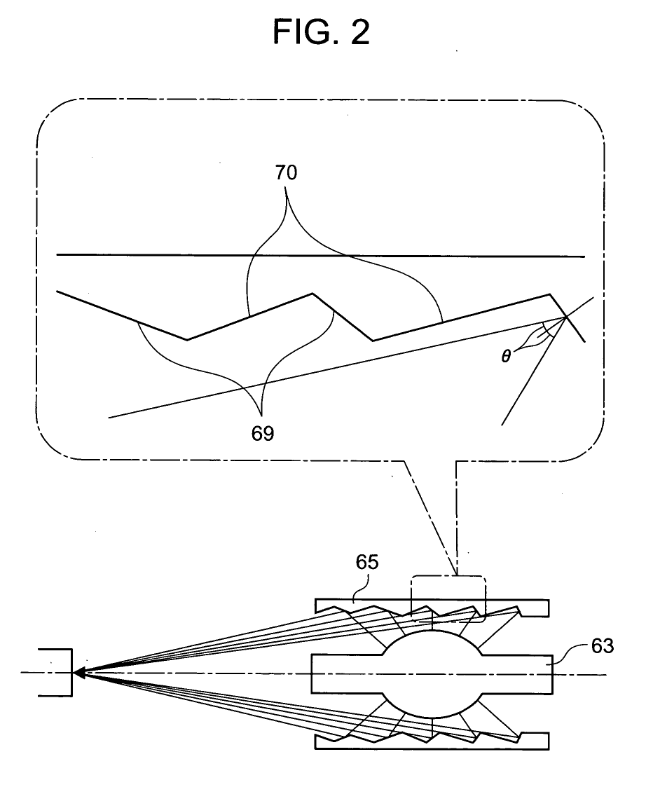

In addition, as is shown in FIG. 2, a number of ring-shaped reflecting surfaces 69 are formed on an inner circumferential surface of the reflector 65.

The shape of a whole reflecting surface formed on the inner circumferential surface of the reflector 65 is formed by alternating the ring-shaped reflecting surface 69 which is a curved surface directed toward the front of the reflector 65 with a ring-shaped rear-facing surface 70 which is a plane of which the surface is directed toward the rear of the reflector 65 in a repeated fashion.

In addition, each reflecting surface 69 is formed into a ring shape made up of a curved surface which is curved slightly so that light emitted from the light source 63 can be gathered to a predetermined position lying forward of the reflector 65 in an axial direction thereof by reflecting the light so emitted on the reflecting surfaces 69.

Additionally, the shape of the whole reflecting surface formed on the inner circumferential surface of the reflector 65 is formed into a wavy shape in which the ring-shaped reflecting surface 69 which is the curved surface directed toward the front of the reflector 65 and the ring-shaped rear-facing surface 70 which is the plane of which the surface is directed toward the rear of the reflector 65 are alternated with each other in the repeated fashion.

By forming the ring-shaped reflecting surfaces 69 and the rear-facing surfaces 70 on the inner circumferential surface of the cylindrical body in the way described above, even with the cylindrically shaped reflector 65 having the front and rear diameters which are equal to each other, when light emitted forwards and rearwards from the light source 63 is incident on the reflecting surface 69 at a predetermined angle θ, so that the incident light is reflected on the reflecting surface 69 at the predetermined angle θ, the light reflected on the single ring-shaped reflecting surface 69 is gathered to the predetermined point.

In addition, each ring shaped reflecting surface 69 is formed into the curved surface so that light reflected on the other ring-shaped reflecting surfaces 69 is also gathered to the same point, and angles at which the reflecting surfaces 69 intersect the axial direction of the reflector 65 are changed slightly individually and sequentially.

Consequently, light emitted from the light source 63 is reflected by the reflecting surfaces in such a manner that all the light reflected can be gathered to the single point lying forward of the reflector 65 in the axial direction thereof.

In addition, since the number of ring-shaped reflecting surfaces 69 are disposed in the axial direction of the reflector 65 and the reflector 65 is formed into the cylindrical body of which the front and rear diameters are equal to each other, even in case the diameter of the reflector 65 is reduced, so as to reduce the size of the light source apparatus 61, light from the light source 63 can be gathered to the predetermined point forwards of the reflector 65 in the axial direction thereof.

Additionally, the shape of the ring-shaped reflecting surface 69 is preferably formed into a Fresnel shape in which an inner surface of a paraboloid of revolution or an ellipsoid of revolution is divided finely and portions containing a curved surface are cut out to be aligned in a wavy form on the inner circumferential surface of the cylindrical body.

However, there may also occur a case where the individual ring-shaped reflecting surfaces 69 are formed into planar ring shapes which are each angled differently in a sequential fashion, that is, the shape of a circumferential side surface of a frustum of a cone.

Thus, in the event that the reflecting surface 69 is formed into the planar ring shape, the reflecting surface 69 can easily be formed, and in the event that a pitch at which the reflecting surfaces 69 and the rear-facing surfaces 70 are disposed is reduced, light reflected on the individual reflecting surfaces 69 can be gathered to a predetermined focal point efficiently without letting it scatter.

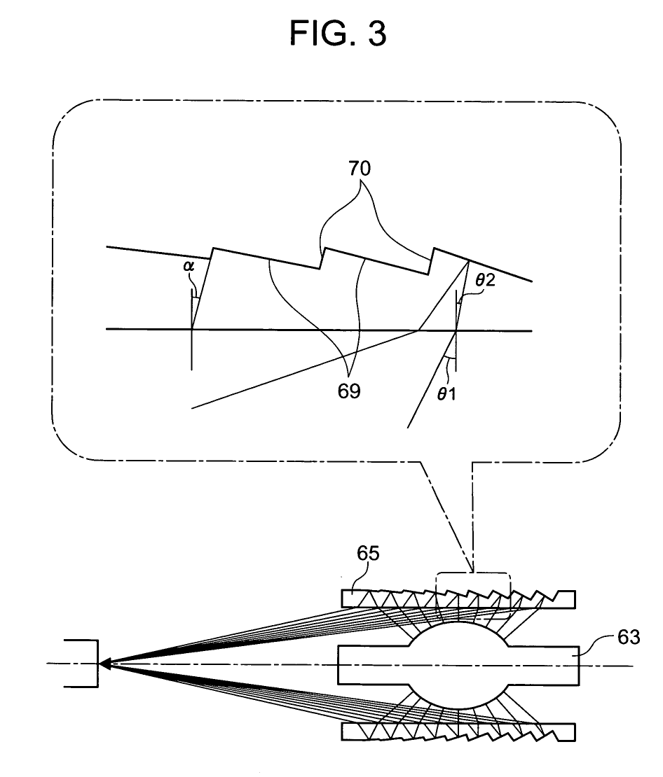

In addition, there may also occur a case where, as is shown in FIG. 3, ring-shaped reflecting surfaces 69 are formed on an outer circumferential surface of a reflector 65. When forming the reflecting surfaces 69 by molding or cutting, the formation of the reflecting surfaces 69 is facilitated by forming the reflecting surfaces 69 on the outer circumferential surface of the reflector 65 in this way, and additionally, the reflecting surfaces 69 can easily be polished.

Note that the reflectance of the reflecting surfaces 69 is preferably increases by using a metallizing processing.

In addition, the reflector 65 in which the reflecting surfaces 69 are formed on the outer circumferential surface thereof is formed of a transparent material, so that light emitted from the light source 63 transmits through the reflector 65 so as to be reflected by the reflecting surfaces 69 formed on the outer circumferential surface of the reflector 65 to thereby be emitted and gathered forwards.

As this occurs, when entering an interior of the reflector 65, light emitted from the light source 63 is refracted, and an exit angle θ2 at which light exits from an inner circumferential surface towards the outer circumferential surface of the reflector 65 becomes smaller than an incident angle θ1 at which light is incident on the inner circumferential surface, and by causing light to be reflected on the reflecting surface 69, light advances towards the front of the reflector 65, and when exiting from a forming layer of the reflector 65 where the reflecting surfaces 69 are formed, light can be refracted in such a manner that an exit angle from the inner circumferential surface becomes larger than the incident angle on the inner circumferential surface of the reflector 65.

Due to this configuration, when light from the light source 63 is reflected by the reflector 65 so as to be gathered to the predetermined position lying ahead of the reflector 65 in the axial direction thereof, the exit angle θ2 at which light is directed from the inner circumferential surface towards the outer circumferential surface of the reflector 65 is made smaller than the incident angle θ1 at which light is incident on the inner circumferential surface, and the angle α of the rear-facing surface 70 is reduced, so that an elevation between the reflecting surface 69 and the reflecting surface 69 adjacent thereto is increased even in the event that an axial width of the rear-facing surface 70 is narrow, whereby the axial width of the reflecting surface 69 can be increased while the reflector 65 is held as the cylindrical body having the same constant diameter.

Consequently, much of light from the light source 63 can be made to be incident on the reflecting surfaces 69 so as to be reflected therefrom, thereby making it possible to increase further the reflection efficiency.

In addition, the shape of the reflector 65 is not limited to the cylindrical shape in which the front and rear diameters are made equal to each other and, hence, may be formed into a frustum of a cone or a barrel-like cylindrical body in which a front diameter is slightly larger than a rear diameter and a middle part of the cylindrical body is curved outwards in a convex fashion.

Thus, by forming the reflector 65 into the cylindrical body in which the front diameter is made larger than the rear diameter, the proportion of reflecting surfaces 69 in an axial unit length of the reflector 65, thereby making it possible to enhance the reflection efficiency.

In addition, the reflecting surface 69 which is formed into the wavy shape is not limited to the curved shape such as the Fresnel surface and, hence, there may occur a case where the reflecting surface 69 is formed into a ring shape made up of a flat plane of the shape of a frustum of a cone.

Additionally, the light source 63 is such as to be disposed at the center of the reflector 65, whereby reflected light by the reflector 65 can easily be gathered to a single point, and a further increase in light gathering efficiency can be facilitated.

In addition, by forming the reflector 65 of heat-resistant glass, a light source such as a discharge lamp which is heated to a high temperature can be used. Additionally, depending on light sources 63 to be used, heat-resistant plastic such as acrylic resin and other materials can be used.

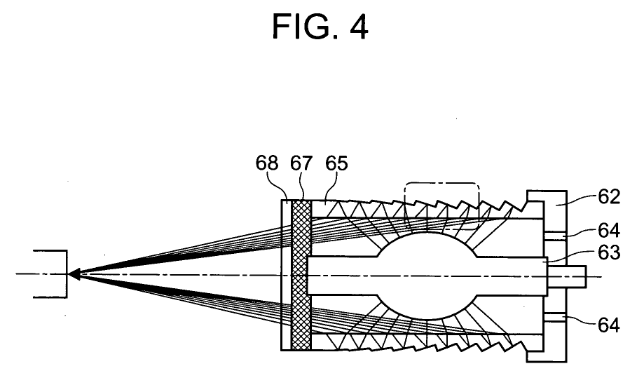

In addition, when a discharge lamp having a high luminance such as an extra-high voltage mercury lamp is used as the light source 63, an explosion-proof glass 68 having the substantially same diameter as an outside diameter of the reflector 65 is disposed in front of the cylindrically-shaped reflector 65 as shown in FIG. 4, and a lamp fixing portion 62 having a diameter larger than the outside diameter of the reflector 65 is provided at the rear of the reflector 65, and the reflector 65 is fixed in place in such a manner as to cover the rear of the reflector 65 by the lamp fixing portion 62. Then, one end of the light source 63 is supported on the lamp fixing portion 62 so that the reflector 65 and the light source 63 are fixed together.

A ventilation ring 67, which is an annular net element, is disposed between the explosion-proof glass 68 and the reflector 65 in such a manner as to be held therebetween, and a ventilation hole 64 is provided in the lamp fixing portion 62 at the rear, so as to allow the passage of cooling air through the interior of the reflector 65.

Thus, by disposing the ventilation ring 67 and providing the ventilation hole 64 in the lamp fixing portion 62, cooling air can be introduced into the interior of the reflector 65, so that heat of the extra-high voltage mercury lamp which is heated to the high temperature during use can be dissipated so as to carry out the cooling of the ultra-high voltage mercury lamp effectively.

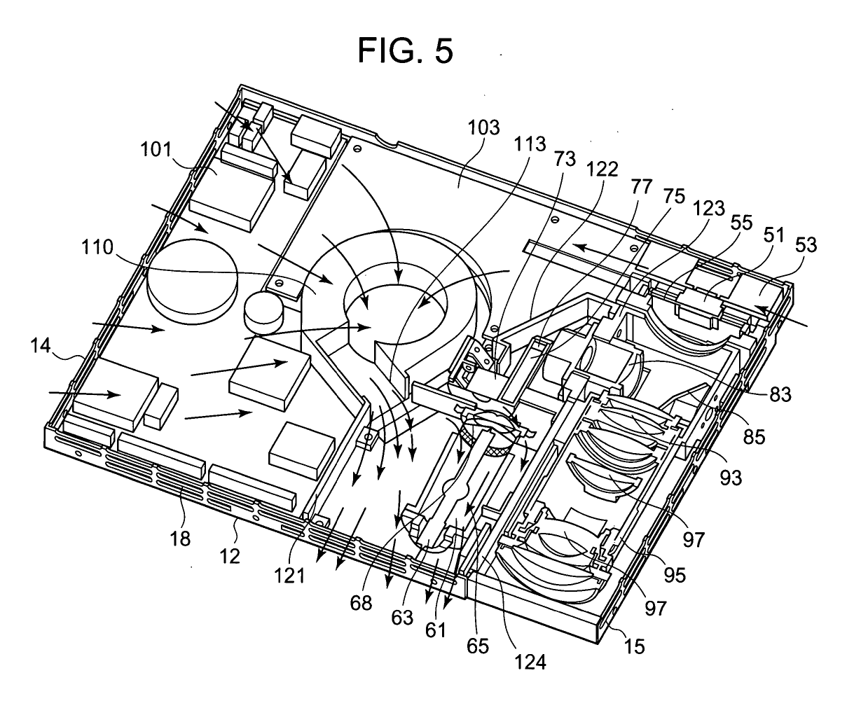

The light source apparatus 61 which uses the discharge lamp having a high luminance such as an extra-voltage mercury lamp as the light source 63 is a light source apparatus 61 which is suitable for use in a data projector or the like, and as is shown in FIG. 5, the light source 61 is combined with a blower 110 to be incorporated in a casing of the projector.

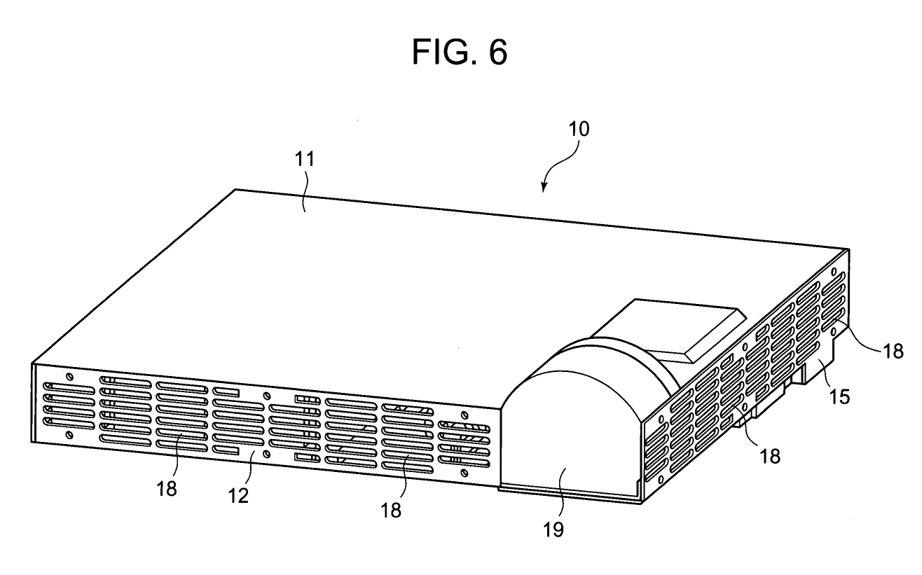

A data projector which utilizes this light source apparatus 61 is formed into substantially the shape of a regular parallelepiped as is shown in FIG. 6 and has a lens cover 19 provided to a side of a front plate 12 which constitutes part of a main body casing in such a manner as to cover a projection opening lying thereat, and a plurality of ventilation holes 18 are provided in this front plate 12.

In addition, although not shown in FIG. 6, a key/indicator unit is provided on an upper plate 11 which constitutes part of the main body casing, and provided on this key/indicator unit are keys and indicators such as a power supply switch key and a power indicator which informs that a power supply is switched on or off, a lamp switch key by which the lamp of the light source apparatus is turned on and a lamp indicator which indicates that the lamp is turned on, and an overheat indicator which informs of the overheat of the light source apparatus and the like when the apparatus overheats.

Furthermore, on a back side of the main body casing, which is not shown, an input/output connector portion where USB terminal and image signal inputting D-SUB terminal, S terminal, and RCA terminal are provided and an Ir reception unit for receiving control signals from a power supply adapter plug and a remote controller are provided in a back plate 13.

In addition, a plurality of ventilation holes 18 are provided in a right-hand side plate 14 of the main body casing, which is not shown, and a left-hand side plate 16, which is shown in FIG. 6, respectively.

Additionally, a microcomputer as a control unit is incorporated in an interior of the main body casing, and when the lamp switch key is operated, the lamp of the light source apparatus 61 is turned on by the power supply control circuit.

In addition, as shown in FIG. 5, a power supply circuit block 101 which incorporates therein the power supply control circuit is disposed in the vicinity of the right-hand side plate 14, and a sirocco fan-type blower 110 is disposed substantially at the center of a bottom plate as a cooling fan. An outlet port 113 of the blower 110 which is made to function as the cooling fan is fixed while being directed towards the light source apparatus 61 which incorporates therein the discharge lamp, and a projection side optical system is disposed along the left-hand side plate 15, the light source apparatus 61 and a light source side optical system being disposed inside the projection side optical system.

In addition, circuit devices such as the microcomputer, ROM, RAM and IC are mounted on a control circuit substrate 103 which functions as a main control substrate, and the power supply control circuit of a power system is incorporated in the lamp power supply circuit block 101.

In addition, an optical systems of the projector 10 is made up of the light source apparatus 61 in which the extra-high voltage mercury lamp is provided as the light source 63 in the interior of the cylindrically shaped reflector 65 which is covered at the front side thereof by the explosion-proof glass 68, a light source side optical system for emitting light emitted from the light source apparatus 61 on to a DMD (digital micromirrors device) which is made to function as a display device 51, the display device 51, and a group of lenses of the projection side optical system for emitting light which is reflected by the display device 51 to form an image on to a screen.

This light source side optical system is made up of a collar wheel which has a color filter provided on a circumference thereof for splitting light emitted from the light source apparatus 61 into a ray of red light, a ray of green light and a ray of blue light and which is rotated by a wheel motor 73, a light guiding rod 75 which allows the passage of light which has transmitted through the filter of the color wheel, a prism 77 which redirects the orientation of light emitted from the light guiding rod 75, a light source side lens group 83 made up of a plurality of lenses for gathering light which has transmitted through the prism 77 on to the display device 51 and a mirror 85 for emitting light that has transmitted through the light source side lens group 83 on to the display device 51 at a predetermined angle.

Furthermore, a variable focus lens having a zooming function is provided as the projection side optical system which are made up of a stationary lens group 93 which is incorporated in a stationary lens barrel and a movable lens group 97 which is incorporated within a movable lens barrel.

Thus, in the projector, single-color image data of red, green and blue are written on the display device 51 by light emitted from the light source unit 61 via the color filter in synchronism with projection periods of rays of red light, green light and blue light, whereby single-color images of red, green and blue are formed sequentially on the display unit 51 by on-state rays of light which are reflected in a front side direction of the display unit 51, so that single-color image light of red, green and blue which is emitted sequentially from the display device is projected on to a projecting surface while being enlarged by the lens groups 95, 97 of the projection side optical system, a full-color image in which the three single-color images of red, green and blue are overlapped on each other being thereby displayed on the projecting surface.

In addition, in this projector, the light source apparatus 61 is accommodated in an interior of a lamp house which is defined by a primary bulkhead 121, a second bulkhead 122, a third bulkhead 123 through which the light source side lens group 83 is passed and a fourth bulkhead 124 which separates the projection side optical system.

Additionally, air lying in the vicinity of the blower 110 is sucked by means of the blower 110 which is made to function as the cooling fan so that outside air so sucked is then sucked further into the interior of the projector 10 from the number of ventilation holes 18 provided in the main body casing of the projector 10, and air staying on the periphery of the color wheel and the light source apparatus 61 is caused to flow by a flow of exhaust air which is blown into the lamp house from the outlet port 113 so as to cool the light source apparatus 61 and the color wheel, the air used to cool the light source apparatus 61 and the color wheel in that way being then discharged to the outside of the projector 10 from the ventilation holes 18 in the front plate 12.

Thus, the light source apparatus 61 of the embodiment of the invention can be made small in size or thin in thickness by utilizing the cylindrically shaped reflector 65 and at the same time can make equipment in which the light source apparatus 61 is incorporated small in size or thin in thickness, and even in the event that the light source 63 such as the extra-voltage mercury lamp which is heated to a high temperature is used, the light source apparatus 61 can be cooled easily.

In addition, the invention is not limited to the embodiment that has been described heretofore and, hence, can be modified in various ways without departing from the spirit and scope of the invention in a working state of the invention. Additionally, the functions worked in the aforesaid embodiment may be combined in a proper fashion as much as possible. The embodiment contains the inventions in various stages, and various inventions can be extracted by properly combining the constituent elements that are disclosed. For example, even in the event that some constituent elements are deleted from all the constituent elements shown in the embodiment, a configuration which results from the deletion of the constituent elements can be extracted as an invention, provided that an advantage can be obtained.

An optical modulation device that is to be installed on the projector described in the subject patent application may take any of the forms of DMD, LCD, LCOS, GXL and the like.

In addition, while the light source installed in the projector described in the subject patent application is described as being the mercury discharge lamp or the light emitting diode, any other form of light source may be adopted.

What is claimed is:

1. A light source apparatus comprising a light source which is provided in an interior of a reflector which is formed into a cylindrical body, in which a number of ring-shaped reflecting surfaces are provided on the cylindrical body for gathering emitted light in an axial direction of the cylindrical body.

2. A light source apparatus as set forth in claim 1, wherein the light source is positioned at the center of the reflector.

3. A light source apparatus as set forth in claim 1, wherein the reflector is the cylindrical body in which a front diameter is slightly larger than a rear diameter.

4. A light source apparatus as set forth in claim 2, wherein the reflector is the cylindrical body in which a front diameter is slightly larger than a rear diameter.

5. A light source apparatus as set forth in claim 1, wherein the reflector is the cylindrical body in which the front diameter and the rear diameter are equal to each other.

6. A light source apparatus as set forth in claim 2, wherein the reflector is the cylindrical body in which the front diameter and the rear diameter are equal to each other.

7. A light source apparatus as set forth in claim 1, wherein the a number of ring-shaped reflecting surfaces are formed into a wavy shape on an inner circumferential surface of the reflector.

8. A light source apparatus as set forth in claim 2, wherein the a number of ring-shaped reflecting surfaces are formed into a wavy shape on an inner circumferential surface of the reflector.

9. A light source apparatus as set forth in claim 3, wherein the a number of ring-shaped reflecting surfaces are formed into a wavy shape on an inner circumferential surface of the reflector.

10. A light source apparatus as set forth in claim 4, wherein the a number of ring-shaped reflecting surfaces are formed into a wavy shape on an inner circumferential surface of the reflector.

11. A light source apparatus as set forth in claim 1, wherein the a number of ring-shaped reflecting surfaces are formed into a wavy shape on an outer circumferential surface of the reflector.

12. A light source apparatus as set forth in claim 2, wherein the a number of ring-shaped reflecting surfaces are formed into a wavy shape on an outer circumferential surface of the reflector.

13. A light source apparatus as set forth in claim 3, wherein the a number of ring-shaped reflecting surfaces are formed into a wavy shape on an outer circumferential surface of the reflector.

14. A light source apparatus as set forth in claim 4, wherein the a number of ring-shaped reflecting surfaces are formed into a wavy shape on an outer circumferential surface of the reflector.

15. A light source apparatus as set forth in claim 7, wherein the reflecting surfaces are formed into a Fresnel shape.

16. A light source apparatus as set forth in claim 11, wherein the reflecting surfaces are formed into a Fresnel shape.

17. A light source apparatus as set forth in claim 1, wherein the reflector is formed of a heat-resistant glass.

18. A light source apparatus as set forth in claim 1, wherein the light source is made to be a discharge lamp having a high luminance.

19. A light source apparatus as set forth in claim 1, wherein the reflector has an explosion-proof glass forwards in a light emitting direction.

20. A projector comprising a light source apparatus, a light source side optical system, a display device, a projection system lens, and furthermore, a power supply circuit and a projector control circuit, wherein
the light source apparatus comprises a discharge lamp having a high luminance at the center of a reflector which is formed into a cylindrical body, and has
a number of ring-shaped reflecting surfaces on an outer circumferential surface of the reflector for gathering light in an axial direction of the cylindrical shape,
the reflecting surfaces being disposed in such a manner as to gather light emitted from the discharge lamp having a high luminance which is made to function as a light source forwards in an axial direction of the reflector.
